(19) United States
(12) Patent Application Publication
(10) Pub. No.: US 2025/0266200 A1
(43) Pub. Date: Aug. 21, 2025

(54) TRANSFORMER STRUCTURE

(71) Applicant: STMicroelectronics International N.V., Geneva (CH)

(72) Inventor: Valerie DANELON, Grenoble (FR)

(21) Appl. No.: 19/047,169

(22) Filed: Feb. 6, 2025

(30) Foreign Application Priority Data
Feb. 19, 2024 (FR) FR2401615

(51) Int. Cl. H01F 19/04; H01F 17/00; H01F 17/02

(52) U.S. Cl. CPC H01F 19/04; H01F 17/0006; H01F 17/02; H01F 2017/0073

(57) ABSTRACT

A transformer is provided. An example transformer comprises two inductors. The first inductor comprising a loop comprising conductive tracks in first and second levels of the structure, the conductive tracks being adapted to being electrically connected to each other directly, or via an intermediate conductive track, over at least half the length of the loop. Over at least half the length of the loop, the conductive tracks are arranged so that, in a cross-section view perpendicular to the length of the first loop, the center of mass of the first conductive track is laterally offset from the center of mass of the second conductive track in the cross-section plane, and in a direction parallel to the plane formed by the first level.

### CROSS REFERENCE TO RELATED APPLICATION(S)

This application claims the priority benefit of French patent application number FR2401615, filed on Feb. 19, 2024, entitled “Structure d′un Transformateur”, which is hereby incorporated by reference to the maximum extent allowable by law.

### TECHNICAL FIELD

The present disclosure generally concerns transformers and transformer manufacturing methods.

### BACKGROUND

A transformer generally comprises two magnetically-coupled inductors, and transfers power from one inductor to the other. Transformers can be used for a variety of applications, such as to perform power adaptation or convert differential signals to common mode and vice versa, as the name suggests, with a balun (“balanced-unbalanced”). In particular, an impedance transformer is an electronic component aiming at modifying the impedance between two terminals of an electronic circuit. There exists a need for transformers with a higher performance and/or operational over a wider frequency range and/or with better capacitive coupling between inductances.

### BRIEF SUMMARY

An embodiment provides a transformer comprising, in a laminated structure, a first inductor and a second inductor, the first inductor comprising:
a first loop comprising a first conductive track in a first level of the structure and a second conductive track in a second level of the structure, the first and second conductive tracks being adapted to being electrically connected to each other directly, or by an intermediate conductive track, over at least half the length of the first loop;
   wherein, over at least half the length of the first loop, the first and second conductive tracks are arranged so that, in a cross-section view perpendicular to the length of the first loop, the center of mass of the first conductive track is laterally offset from the center of mass of the second conductive track in the cross-section plane, and in a direction parallel to the plane formed by the first level.

According to an embodiment, the first and second conductive tracks are connected together by the intermediate conductive track, the intermediate conductive track comprising one or a plurality of vias.

According to an embodiment, the first loop further comprises a third conductive track electrically connected to the second conductive track over at least half the length of the first loop, wherein the second conductive track comprises one or a plurality of vias coupling the first conductive track to the third conductive track.

According to an embodiment, the second inductor comprises a first loop comprising a fourth conductive track in the first level of the structure and a fifth conductive track in the second level of the structure.

According to an embodiment, the first conductive track of the first loop of the first inductor in the first level at least partially faces the fifth track of the first loop of the second inductor in the second level.

Another embodiment provides a method of manufacturing a transformer comprising, in a laminated structure, a first inductor and a second inductor, the method comprising:
the forming, in a first level of the structure, of a first conductive track of a first loop of a first inductor;
the forming, in a second level of the structure, of a second conductive track of the first loop, the first and second conductive tracks being adapted to being electrically connected to each other directly, or via an intermediate conductive track, over at least half the length of the first loop;
   wherein, over at least half the length of the first loop, the first and second conductive tracks are arranged in such a way that, in a cross-section view perpendicular to the length of the first loop, the center of mass of the first conductive track is laterally offset from the center of mass of the second conductive track in the cross-section plane, and in a direction parallel to the plane formed by the first level.

According to an embodiment, the first and second conductive tracks to each are connected other by the intermediate conductive track, the method further comprising, after the forming of the first conductive track and before the forming of the second conductive track, the forming of at least one via forming the intermediate conductive track on the first conductive track, the second conductive track being formed on the at least one via so that the first and second conductive tracks are electrically connected to each other via the at least one via.

According to an embodiment, the second conductive track comprises one or a plurality of vias, the method further comprising, after the forming of the second conductive track, the forming of a third conductive track on the second conductive track, the third conductive track being electrically connected to the second conductive track over at least half the length of the first loop.

According to an embodiment, the method further comprises:
the forming, in the first level of the structure, of a fourth conductive track of a first loop of the second inductor;
the forming, in the second level of the structure, of a fifth conductive track of the first loop of the second inductor.

According to an embodiment, the fifth track of the first loop in the second level is shaped so that the first conductive track of the first loop in the first level at least partially faces the fifth track of the first loop in the second level.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a top view of a transformer comprising two inductors;

FIG. 2 is a partial cross-section view of the transformer of FIG. 1;

FIG. 3 is a top view of a transformer according to an embodiment of the present disclosure;

FIG. 4 is a partial cross-section view of the transformer of FIG. 3, according to an embodiment of the present disclosure;

FIG. 5A is a graph showing the value of the first inductor of the transformer of FIGS. 1 and 3 as a function of the operating frequency of the transformer;

FIG. 5B is a graph showing the value of the second inductance of the transformer of FIGS. 1 and 3 as a function of the operating frequency of the transformer;

FIG. 5C is a graph showing the value of the mutual coupling parameter between the two inductances s of the transformer of FIGS. 1 and 3 as a function of the operating frequency of the transformer;

FIG. 5D is a graph showing the series resistance of the first inductance of the transformer of FIGS. 1 and 3 as a function of the operating frequency of the transformer;

FIG. 5E is a graph showing the series resistance of the second inductance of the transformer of FIGS. 1 and 3 as a function of the operating frequency of the transformer;

FIG. 6A is a graph showing scattering parameters for the input, output, and transmission adaptation of the signal by the transformers of FIGS. 1 and 3 at a 25-GHz frequency;

FIG. 6B is a graph showing scattering parameters for the signal input, output, and transmission adaptation by the transformers of FIGS. 1 and 3 at a 20-GHz frequency;

FIG. 6C is a graph showing scattering parameters for the input, output, and transmission adaptation of the signal by the transformers of FIGS. 1 and 3 at a 42-GHz frequency;

FIG. 7A is a top view of an example of a transformer according to an embodiment of the present disclosure;

FIG. 7B and FIG. 7C are top views of a first and of a second inductor of the transformer of FIG. 7A;

FIG. 8A is a graph showing scattering parameters for the input, output, and transmission adaptation of the signal by the transformers of FIGS. 1 and 3 at a 12-GHz frequency;

FIG. 8B is a graph showing scattering parameters for the input, output, and transmission of the signal by the transformers of FIGS. 1 and 3 at a 9-GHz frequency;

FIG. 8C is a graph showing scattering parameters for the input, output, and transmission adaptation of the signal by the transformers of FIGS. 1 and 3 at a 13-GHz frequency; and

FIG. 9 is a partial cross-section view of the transformer of FIG. 1, according to another example than that of FIG. 2 and according to an embodiment of the present disclosure.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the rest of the disclosure, transformers formed in a laminated structure are considered. By “laminated structure”, there is meant a stack of insulating and conductive levels coating a substrate. There is here called “conductive level” a set of conductive tracks defined in a same layer of a conductive material, for example a metal, for example copper.

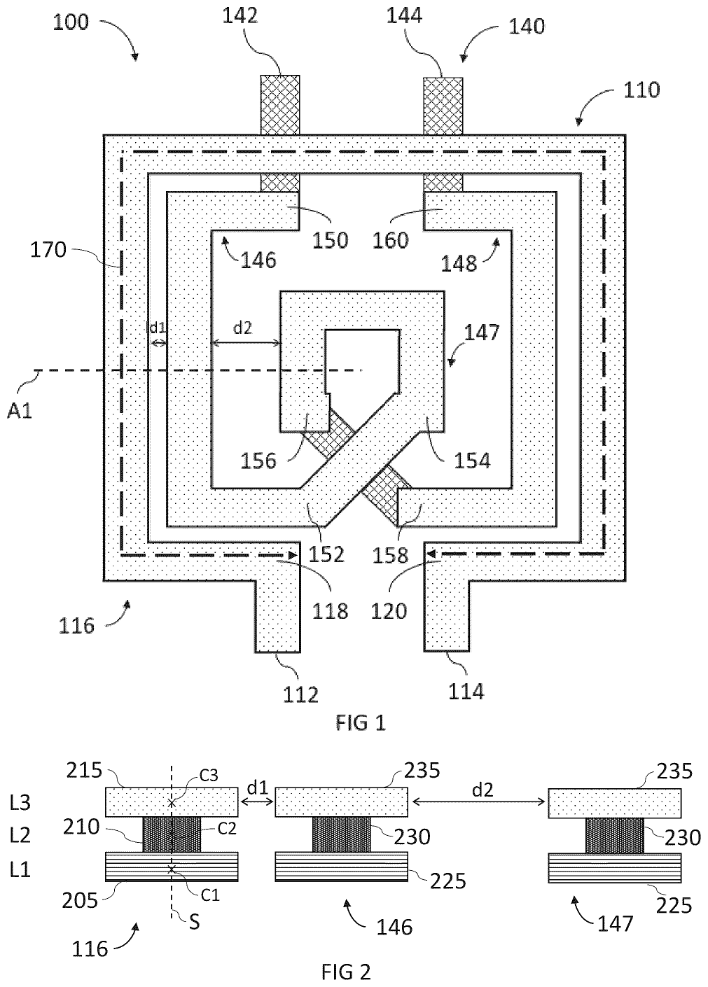

FIG. 1 is a top view of an example of a transformer 100 comprising two inductors 110, 140. For example, transformer 100 is used as a balun and power adapter: a common-mode signal is for example transformed into a differential-mode signal, the input impedance is for example adapted to 50 Ohms, the output impedance is for example adapted to 100 Ohms.

According to an embodiment, the first inductor 110 is connected to a first external electronic circuit (not shown in FIG. 1) and the second inductor 140 is connected to a second external electronic circuit (also not shown in FIG. 1).

Inductor 110 comprises two connection terminals, for example an input/output terminal 112 and an input/output terminal 114. Inductor 110, as shown in the example of FIG. 1, comprises a loop 116, that is, one or a plurality of conductive tracks coupled together and comprising a full circle, coupling a first end 118 to a second end 120. The first end 118 is for example coupled to connection terminal 112, and the second end 120 is for example coupled to connection terminal 114.

Inductor 140 comprises two connection terminals, for example an input/output terminal 142 and an input/output terminal 144. Inductor 140, as shown in the example in FIG. 1, comprises two loops: a first loop formed by the two half-loops 146 and 148, and a second loop 147. The first half-loop 146 of the first loop couples an end 150 to an end 152. End 150 is for example coupled to connection terminal 142. The second loop 147 couples an end 154 to an end 156. End 154 is for example coupled to end 152 via one or a plurality of conductive tracks. The second half-loop 148 of the first loop couples an end 158 to an end 160. End 158 is for example coupled to end 156 via one or a plurality of conductive tracks and/or one or a plurality of vias. End 160 is for example coupled to connection terminal 144.

In the example of FIG. 1, loops 116 and 147 and the loop formed by the assembly of half-loops 146 and 148, have a substantially rectangular shape. In other embodiments, the loops are, for example, other than rectangular in shape, such as octagonal, circular, etc.

The loop 116 of the first inductor 110, the two half-loops 146, 148 of the second inductor 140, and the second loop 147 of the second inductor 140 are formed by a stack of three conductive tracks, each being in a separate level, as will be described in relation to FIG. 2. Even if the loop 116 is formed by a stack of three conductive tracks, it is one single loop because the tracks are connected in parallel with each other and are connected together along at least half of their length. The loop 116 generates an electromagnetic field that is different from an electromagnetic field that would be generated by two or three loops connected in series via their extremities and stacked.

In the example of FIG. 1, the loop 116 has a length 170, illustrated by a double-headed arrow.

FIG. 2 schematically shows a partial cross-section view of the transformer 100 of FIG. 1 along an axis A1 shown in FIG. 1, running through loop 116, half-loop 146, and loop 147.

The loops of the inductors 110 and 140 of the transformer 100 of FIG. 1 each comprise, for example, conductive tracks in levels L1, L2, L3, so that level L2 is intermediate to levels L1 and L3. Levels L1 and L3 are, for example, metallization levels and level L2 is, for example, an insulating level in which vias may be formed to couple conductive tracks of the metallization levels. Conductive tracks formed in level L2 are, for example, vias.

Loop 116 comprises a conductive track 205 in level L1, a conductive track 210 in level L2, and a conductive track 215 in level L3.

Half-loop 146 comprises a conductive track 225 in level L1, a conductive track 230 in level L2, and a conductive track 235 in level L3.

A distance d1 separates loop 116 and half-loop 146 at axis A1, and a distance d2 separates half-loop 146 and loop 147 at axis A1, these distances d1 and d2 also being shown in FIG. 1. In the example of FIGS. 1 and 2, distance d2 is greater than distance d1.

In the cross-section view of FIG. 2, the conductive tracks 205, 210, and 215 of each loop are centered on a same axis S, that is, their cross-sections have their centers of mass, C1, C2, and C3 respectively, aligned along axis S. Axis S is in the cross-section plane of FIG. 2 and perpendicularly intersects levels L1, L2, and L3. For the definition of the center of mass, it is considered that each of conductive tracks 205, 210, and 215 has a uniform density.

Referring once again to FIG. 1, loop 116, each of half-loops 146, 148, and loop 147 comprise conductive tracks in levels L1, L2, and L3 coupled to each other over the entire length of the loop. The conductive tracks coupling ends 156 and 158, end 150 to connection terminal 142 and end 160 to connection terminal 144 comprise, for example, a single conductive track formed in a single level which is, for example, a level other than levels L1, L2, and L3. Generally speaking, each of the inductor loops comprises at least two conductive tracks coupled together over at least half the length of the loop.

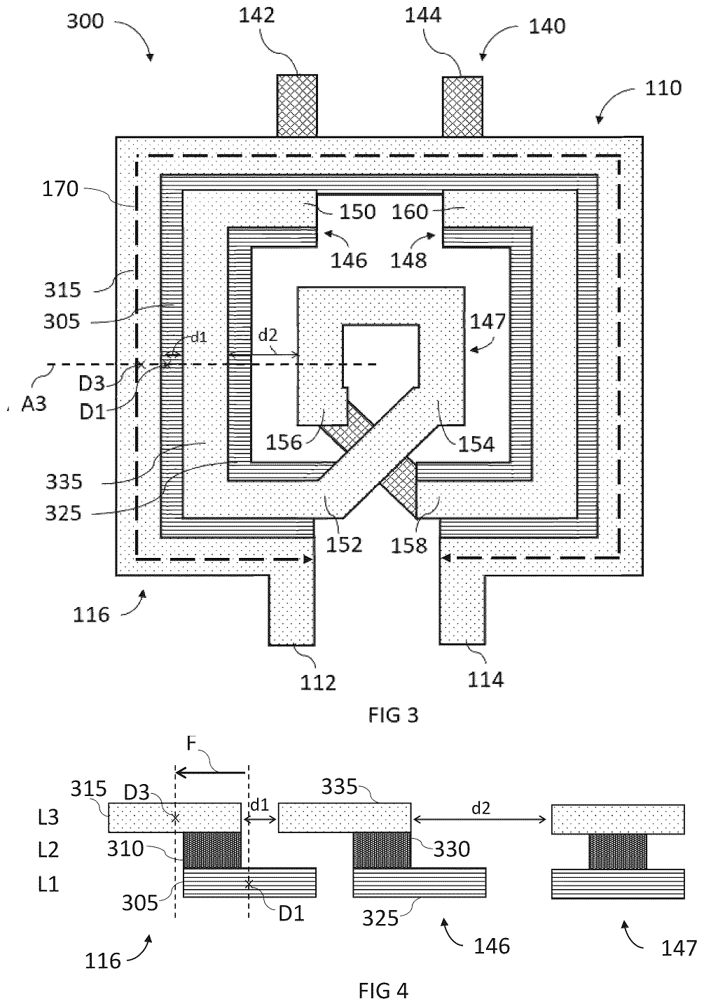

FIG. 3 is a top view of an example of a transformer 300 according to an embodiment of the present disclosure. For example, transformer 300 is an impedance transformer.

Some of the elements of FIG. 3 correspond to elements of FIG. 1 or of FIG. 2. These elements are designated with a same reference and are not described again in detail.

The transformer 300 of FIG. 3 corresponds to the transformer 100 of FIG. 1, in which a conductive track 305 of the layer L1 of loop 116 is offset from a conductive track 315 of the layer L3 of loop 116.

In particular, conductive track 305 is 1 laterally offset so that, for any point of loop 116, in a cross-section view, the center of mass D1 of conductive track 305 is laterally offset from the center of mass D3 of conductive track 315, in the cross-section plane, in a direction parallel to the plane formed by the first conductive level L1. In the example of FIG. 3, conductive track 305 is offset towards the inside of loop 116. According to an alternative embodiment, conductive track 305 is offset towards the outside of loop 116.

In the example of FIG. 3, a conductive track 325 of the layer L1 of half-loops 146 and 148 is also offset similarly to the conductive track 305 of loop 116.

In the example of FIG. 3, none of the conductive tracks of loop 147 is offset.

In FIG. 3, in top view, the tracks of level L3 are fully visible, and those of level L1 are partially visible, when they are not covered by tracks of higher levels. The tracks of level L2 are, in the example of FIG. 3, fully covered by the tracks of level L3 and are not visible. The tracks coupling connection terminals 142 and 144 to ends 150 and 160 respectively, and the tracks coupling ends 156 and 158 are for example formed in a conductive level separate from levels L1, L2, and L3.

FIG. 4 is a partial cross-section view, along an axis A3 of FIG. 3 crossing the loop 116, the half-loop 146, and the loop 147 of the transformer 300 of FIG. 3, according to an embodiment of the present disclosure.

Certain elements of FIG. 4 correspond to elements of FIGS. 1 to 3. These elements are designated with the same reference and are not described again in detail.

In the cross-section view of FIG. 4, the center of mass D3 of the conductive track 315 of loop 116 is laterally offset from the center of mass D1 of the conductive track 305 of loop 116, in the cross-section plane, in a direction parallel to the plane formed by first conductor L1. The lateral displacement of conductive track 315 relative to conductive track 305 is indicated by an arrow F. This displacement F is for example selected so that conductive tracks 305 and 315 remain at least partially opposite each other, to enable an intermediate conductive track 310, in layer L2, to electrically couple conductive tracks 305 and 315.

Although an offset of an upper track with respect to a lower track is described in the example of FIGS. 3 and 4, in other embodiments, an offset of the lower track with respect to the upper track is for example performed.

Similarly, the conductive track 335 of level L3 of half-loop 146 is offset by the lateral displacement F with respect to the conductive track 325 of level L1 of half-loop 146.

The tracks of loop 147 are for example not offset.

The track 310 of level L2 of loop 116 is for example offset to ensure the connection between conductive tracks 305 and 315. Similarly, a track 330 of level L2 of half-loop 146 is for example offset to ensure the connection between conductive tracks 325 and 335.

As described in relation with FIG. 1, distance d1 separates the conductive tracks of level L3 of loop 116 and of half-loop 146 at axis A3, and distance d2 separates the conductive tracks of level L3 of half-loop 146 and of loop 147 at axis A3. In the example of FIG. 4, the lateral displacement F with respect to distance d1 is such that conductive tracks 305 and 335 partially face each other.

More generally, according to the distance separating two adjacent loops and the width of the conductive tracks forming the loops, a conductive track of the first conductive level of one loop does or not partially face a track of the second conductive level of another adjacent loop. An advantage of providing partially opposite conductive tracks is that this improves, according to cases, the compactness of the transformer and/or the magnetic coupling between inductors.

Although in the example of FIGS. 3 and 4, the conductive tracks of loop 116 and of each of half-loops 146 and 148 are laterally offset, in other embodiments, it would be possible to offset the conductive tracks of only one of the half-loops or of half of one of the loops. The applied offset is for example selected according to the desired effect on the output parameters.

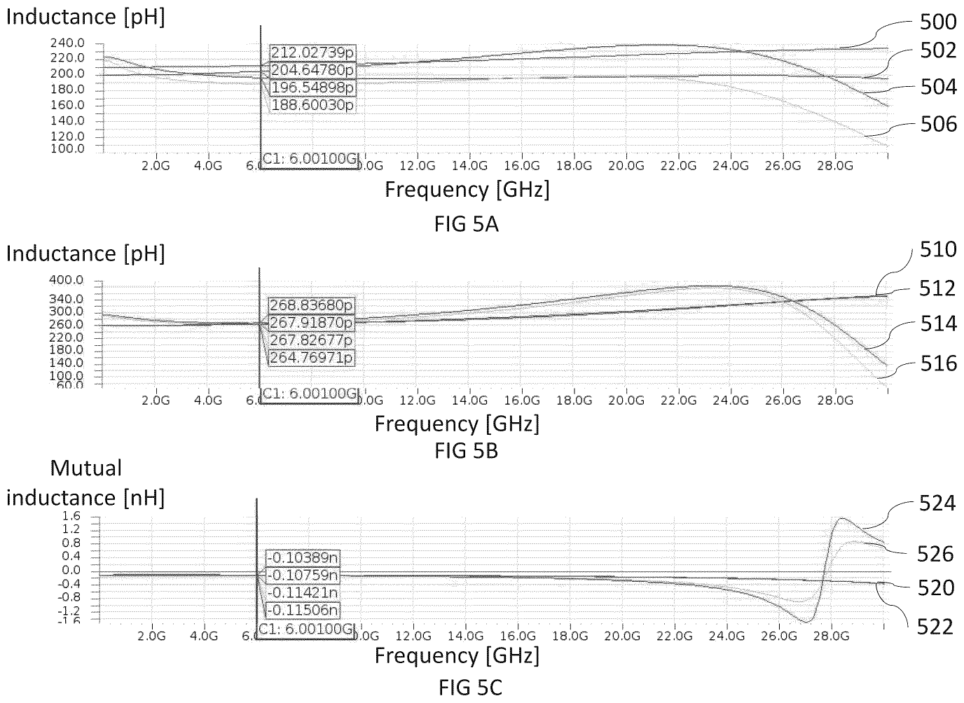

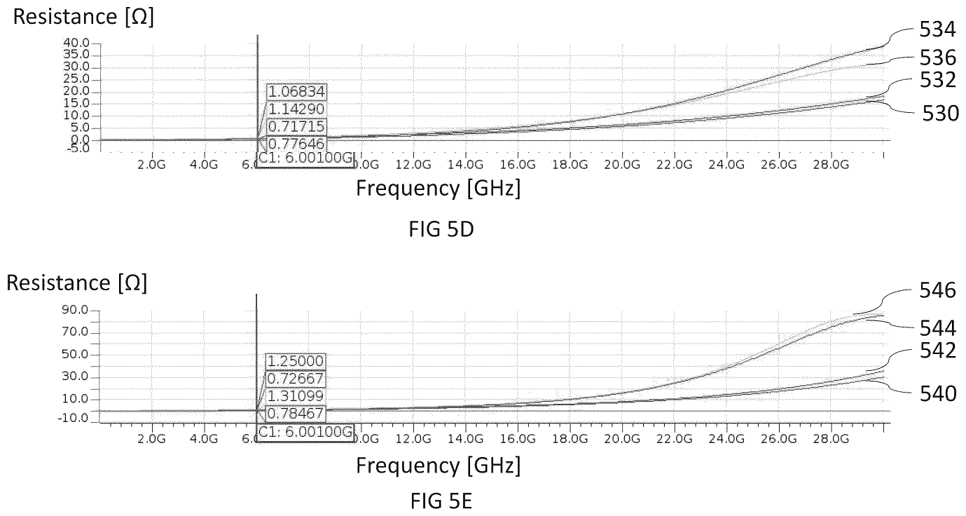

FIG. 5A is a graph showing the value (“Inductance [pH]”) of the first inductance 110 of the transformer 100, 300 of FIGS. 1 and 3 as a function of the operating frequency (“Frequency [GHz]”) of the transformer.

A first curve 500 represents the value of the inductance 110 of the transformer 100 of FIG. 1, such as modeled according to a model using an equivalent diagram of transformer 100 by using a small-signal approximation.

A second curve 502 represents the value of the inductance 110 of the transformer 100 of FIG. 1, obtained by performing a digital or electromagnetic simulation enabling to obtain at the output of the simulation the scattering parameters of the transformer.

For the ensuing comparison in the drawing, a digital simulation is for example carried out, assuming that the first inductor 110 is connected in parallel with a power generator, for example having a 50-Ohm characteristic impedance, and that the second inductor 140 is connected in parallel with a power generator, for example having a 50-Ohm characteristic impedance. The simulation enables to obtain the scattering parameters of the transformer, from which is extracted one of the parameters among the value of inductance 110, the value of the mutual coupling parameter between inductances 110 and 140, and the series resistance of inductance 110. The other two parameters are obtained by using the equivalent diagram of transformer 100, for which the small-signal parameters characteristic of the considered transformer are extracted from this same simulation. The same digital simulation is replicated for the other transformers considered in this comparison.

A third curve 504 represents the value of the inductance 110 of the transformer 300 of FIG. 3, such as modeled according to the model using an equivalent diagram of transformer 100 by using a small-signal approximation.

A fourth curve 506 represents the value of the inductance 110 of the transformer 300 of FIG. 3, obtained by performing the digital simulation.

Over a frequency range, for example between 2 and 22 GHz, the value 500 of the inductance 110 of transformer 100 and the value 504 of the inductance 110 of transformer 300 such as modeled are similar to within 10%.

Over a frequency range, for example between 2 and 22 GHz, the value 502 of the inductance 110 of transformer 100 and the value 506 of the inductance 110 of transformer 300 such as digitally simulated are similar to within 10%.

Over a frequency range, the value of the first inductance 110 varies little when a conductive track is offset with the offset described in relation with FIGS. 3 and 4.

FIG. 5B is a graph showing the value (“Inductance [pH]”) of the second inductance 140 of the transformer 100, 300 of FIGS. 1 and 3 as a function of the operating frequency (“Frequency [GHz]”) of the impedance transformer.

A first curve 510 represents the value of the inductance 140 of the transformer 100 of FIG. 1, such as modeled according to a model using an equivalent diagram of transformer 100 by using the small-signal approximation.

A second curve 512 represents the value of the inductance 140 of the transformer 100 of FIG. 1, obtained by performing the digital simulation described in relation with FIG. 5A.

A third curve 514 represents the value of the inductance 140 of the transformer 300 of FIG. 3, such as modeled according to a model using an equivalent diagram of transformer 100 by using the small-signal approximation.

A fourth curve 516 represents the value of the inductance 140 of the transformer 300 of FIG. 3, obtained by performing the digital simulation described in relation with FIG. 5A.

Over a frequency range, for example between 4 and 10 GHz, the value 510 of the inductance 140 of transformer 100 and the value 514 of the inductance 140 of transformer 300 such as modeled are similar to within 10%.

Over a frequency range, for example between 4 and 10 GHz, the value 512 of the inductance 140 of transformer 100 and the value 516 of the inductance 140 of transformer 300 such as digitally simulated are similar to within 10%.

Over a frequency range, the value of the second inductance 140 varies little when conductive tracks are offset according to the offset described in relation with FIGS. 3 and 4.

FIG. 5C is a graph showing the value of the mutual coupling parameter (“Mutual inductance [nH]”) between the two inductances 110, 140 of the transformer 100, 300 of FIGS. 1 and 3 as a function of the operating frequency (“Frequency [GHz]”) of the impedance transformer.

A first curve 520 represents the value of the mutual coupling parameter between the two inductances 110 and 140 of the transformer 100 of FIG. 1, such as modeled according to a model using an equivalent diagram of the transformer 100 by using the small-signal approximation.

A second curve 522 represents the value of the mutual coupling parameter between the two inductances 110 and 140 of the transformer 100 of FIG. 1, obtained by performing the digital simulation described in relation to FIG. 5A.

A third curve 524 represents the value of the mutual coupling parameter between the two inductances 110 and 140 of the transformer 300 of FIG. 3, such as modeled according to a model using an equivalent diagram of transformer 100 by using the small-signal approximation.

A fourth curve 526 represents the value of the mutual coupling parameter between the two inductances 110 and 140 of the transformer 300 of FIG. 3, obtained by performing the digital simulation described in relation with FIG. 5A.

Over a frequency range, for example between a few MHz and 20 GHz, according to the model, the value of the mutual coupling parameter 524 of transformer 300 having offset conductive tracks is greater, in absolute value, than the value of the mutual coupling parameter 520 of transformer 100 having no offset conductive tracks. For example, for a 6-GHz frequency, the mutual coupling parameter increases by approximately 7% when conductive tracks are offset.

Over a frequency range, for example between a few MHZ and 20 GHz, according to the digital simulation, the value of the mutual coupling parameter 526 of transformer 300 having offset conductive tracks is greater, in absolute value, than the value of the mutual coupling parameter 522 of transformer 100 having no offset conductive tracks. For example, at a 6-GHz frequency, the mutual by coupling parameter increases approximately 10% when conductive tracks are offset.

Over a frequency range, the value of the mutual coupling parameter increases when conductive tracks are offset with the offset described in relation with FIGS. 3 and 4.

FIG. 5D is a graph showing the series resistance (“Resistance [Ω]”) of the first inductor 110 of the transformer 100, 300 of FIGS. 1 and 3 as a function of the operating frequency (“Frequency [GHz]”) of the impedance transformer. The resistor in series with the inductors of an impedance transformer causes losses in the system and impacts the adaptation performance, whereby it is desirable to minimize this value.

A first curve 530 represents the series resistance of the inductor 110 of the transformer 100 of FIG. 1, such as modeled according to a model using an equivalent diagram of transformer 100 by using the small-signal approximation.

A second curve 532 represents the series resistance of the inductor 110 of the transformer 100 of FIG. 1, obtained by performing the digital simulation described in relation with FIG. 5A.

A third curve 534 represents the series resistance of the inductor 110 of the transformer 300 of FIG. 3, such as modeled according to a model using an equivalent diagram of transformer 100 using the small-signal approximation.

A fourth curve 536 represents the series resistance of the inductor 110 of the transformer 300 of FIG. 3, obtained by performing the digital simulation described in relation with FIG. 5A.

Over a frequency range, for example between a few MHz and 10 GHZ, according to the model, the series resistance 534 of the inductor 110 of transformer 300 is greater than the value 530 of the inductance 110 of transformer 100. For example, at a 6-GHz frequency, the resistance is approximately 7% higher when conductive tracks are offset.

Over a frequency range, for example between a few MHz and 10 GHz, according to the model, the series resistance 536 of the inductor 110 of transformer 300 is higher than the value 532 of the inductor 110 of transformer 100. For example, for a 6-GHz frequency, the resistance is around 8% higher when conductive tracks are offset.

Over a frequency range, the series resistance of the first inductor 110 increases slightly and is very little modified when a conductive track is offset with the offset described in relation with FIGS. 3 and 4.

FIG. 5E is a graph showing the series resistance (“Resistance [Ω]”) of the second inductor 140 of the transformer 100, 300 of FIGS. 1 and 3 as a function of the operating frequency (“Frequency [GHz]”) of the impedance transformer.

A first curve 540 represents the series resistance of the inductor 140 of the transformer 100 of FIG. 1, such as modeled according to a model using an equivalent diagram of transformer 100 by using the small-signal approximation.

A second curve 542 represents the series resistance of the inductor 140 of the transformer 100 of FIG. 1, obtained by performing the digital simulation described in relation with FIG. 5A.

A third curve 544 represents the series resistance of the inductor 140 of the transformer 300 of FIG. 3, such as modeled according to a model using an equivalent diagram of the transformer 100 by using the small-signal approximation.

A fourth curve 546 represents the series resistance of the inductor 140 of the transformer 300 of FIG. 3, obtained by performing the digital simulation described in relation with FIG. 5A.

Over a frequency range, for example between a few MHz and 10 GHz, according to the model, the series resistance 544 of the inductor 140 of transformer 300 is higher than the value 540 of the inductor 140 of transformer 100. For example, at a 6-GHz frequency, the series resistance is around 5% higher when conductive tracks are offset.

Over a frequency range, for example between a few MHZ and 10 GHZ, according to the model, the series resistance 546 of the inductor 140 of impedance transformer 300 is higher than the value 542 of the inductor 140 of impedance transformer 100. For example, for a 6-GHz frequency, the series resistance is around 8% higher when conductive tracks are offset.

Over a frequency range, the value of the series resistance of the second inductor 140 is very little modified when a conductive track is offset according to the offset described in relation with FIGS. 3 and 4.

In addition to the results described in FIGS. 5A to 5E resulting from the offset of conductive tracks in a transformer, the capacitive coupling between the two inductors 110 and 140 of the transformer 300 of FIG. 3 is approximately 100% greater than the capacitive coupling of the transformer 100 of FIG. 1.

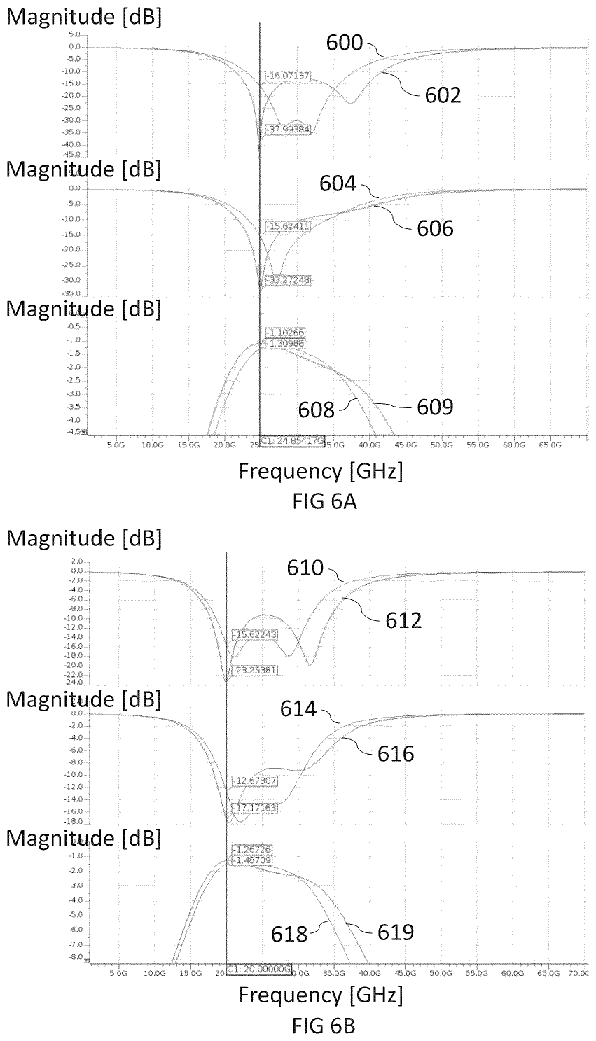

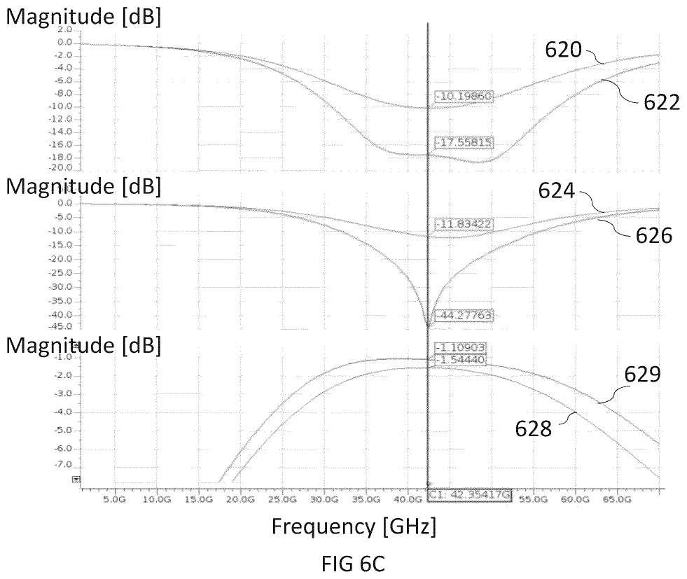

FIGS. 6A to 6C are graphs obtained by means of the digital simulation described in relation with FIG. 5A with the transformer 100 of FIG. 1 and with the transformer 300 of FIG. 3. A first capacitive element and a second capacitive element are added in parallel with each of the inductors 110 and 140 of transformer 300. A first capacitive element and a second capacitive element having the same values are added in parallel with each of the inductors 110 and 140 of transformer 100. The values of the first and second capacitive elements used in the simulation are adjusted according to the operating frequency of the transformer to optimize the power adaptation of the considered transformer. FIGS. 6A to 6C show reflection coefficients S11 of the primary circuit of the transformer comprising the first capacitive element and inductor 110, and S22 of the secondary circuit of the transformer comprising the second capacitive element and inductor 140, characterizing the proportion of power reflected between the considered circuit and what is connected thereto. On design of a transformer, it is desirable for the parameters S11 and S22 to be relatively low, which means that the power reflected at the transformer is relatively low and preferably minimal. A third parameter, S21, is shown in FIGS. 6A to 6C. It is the power gain or loss of the considered transformer 100, 300. On design of a transformer, it is desirable for S21 to be either close to 1, or close to 0 dB, which indicates that the losses relative to the transformer in the considered environment are low and that the power transmitted through the transformer is increased.

Figure a graph showing 6A is the scattering parameters: S11, S22, and S21 of signal transmission by the impedance transformers 100, 300 of FIGS. 1 and 3 at a 25-GHz frequency.

In the example of FIG. 6A, the first and second capacitive elements used for the digital simulation have value 150 fF and 120 fF.

Curve 600 shows the amplitude (“Magnitude [dB]”) of coefficient S11 in decibels of the transformer 100 of FIG. 1 as a function of the operating frequency (“Frequency [GHz]”).

Curve 602 shows the amplitude (“Magnitude [dB]”) of coefficient S11 in decibels of the transformer 300 of FIG. 3 as a function of the operating frequency (“Frequency [GHz]”).

Curve 604 shows the amplitude (“Magnitude [dB]”) of coefficient S22 in decibels of the transformer 100 of FIG. 1 as a function of the operating frequency (“Frequency [GHz]”).

Curve 606 shows the amplitude (“Magnitude [dB]”) of coefficient S22 in decibels of the transformer 300 of FIG. 3 as a function of the operating frequency (“Frequency [GHz]”).

Curve 608 shows the amplitude (“Magnitude [dB]”) of coefficient S21 in decibels of the transformer 100 of FIG. 1 as a function of the operating frequency (“Frequency [GHz]”).

Curve 609 shows the amplitude (“Magnitude [dB]”) of coefficient S21 in decibels of the transformer 300 of FIG. 3 as a function of the operating frequency (“Frequency [GHz]”).

For a 25-GHZ frequency, coefficient S11 is approximately −38 dB for transformer 300, to be compared with −16 dB for transformer 100.

For a 25-GHZ frequency, coefficient S22 is approximately −33 dB for transformer 300, to be compared with −16 dB for transformer 100.

For a 25-GHZ frequency, coefficient S21 is approximately −1.1 dB for transformer 300, to be compared with −1.3 dB for transformer 100.

For a 25-GHZ frequency, for the transformer 300 comprising offset conductive tracks as described in relation with FIGS. 3 and 4, coefficients S11 and S22 are lower and the coefficient S21 is closer to 0 than for the transformer 100 of FIG. 1.

FIG. 6B is a graph showing the scattering parameters: S11, S22, and S21 of signal transmission by the impedance transformers 100, 300 of FIGS. 1 and 3 at a 20-GHz frequency.

In the example of FIG. 6B, the first and second capacitive elements used for the digital simulation have value 245 fF and 169 fF.

Curve 610 shows the amplitude (“Magnitude [dB]”) of coefficient S11 in decibels of the transformer 100 of FIG. 1 as a function of the operating frequency (“Frequency [GHz]”).

Curve 612 shows the amplitude (“Magnitude [dB]”) of coefficient S11 in decibels of the transformer 300 of FIG. 3 as a function of the operating frequency (“Frequency [GHz]”).

Curve 614 shows the amplitude (“Magnitude [dB]”) of coefficient S22 in decibels of the transformer 100 of FIG. 1 as a function of the operating frequency (“Frequency [GHz]”).

Curve 616 shows the amplitude (“Magnitude [dB]”) of coefficient S22 in decibels of the transformer 300 of FIG. 3 as a function of the operating frequency (“Frequency [GHz]”).

Curve 618 shows the amplitude (“Magnitude [dB]”) of coefficient S21 in decibels of the transformer 100 of FIG. 1 as a function of the operating frequency (“Frequency [GHz]”).

Curve 619 shows the amplitude (“Magnitude [dB]”) of coefficient S21 in decibels of the transformer 300 of FIG. 3 as a function of the operating frequency (“Frequency [GHz]”).

For a 20-GHZ frequency, coefficient S11 is approximately −23 dB for transformer 300, to be compared with −16 dB for transformer 100.

For a 20-GHZ frequency, coefficient S22 is approximately −17 dB for transformer 300, to be compared with −13 dB for transformer 100.

At a 20-GHz frequency, coefficient S21 is approximately −1.3 dB for transformer 300, to be compared with −1.5 dB for transformer 100.

For a 20-GHz frequency, for the transformer 300 comprising offset conductive tracks as described in relation with FIGS. 3 and 4, coefficients S11 and S22 are lower and coefficient S21 is closer to 0 than for the transformer 100 of FIG. 1.

FIG. 6C is a graph showing the scattering parameters: S11, S22, and S21 of signal transmission by the impedance transformers 100, 300 of FIGS. 1 and 3 at a 42-GHz frequency.

The first and second capacities used for the digital simulation have value 80 fF and 40 fF.

Curve 620 shows the amplitude (“Magnitude [dB]”) of coefficient S11 in decibels of the transformer 100 of FIG. 1 as a function of the operating frequency (“Frequency [GHz]”).

Curve 622 shows the amplitude (“Magnitude [dB]”) of coefficient S11 in decibels of the transformer 300 of FIG. 3 as a function of the operating frequency (“Frequency [GHz]”).

Curve 624 shows the amplitude (“Magnitude [dB]”) of coefficient S22 in decibels of the transformer 100 of FIG. 1 as a function of the operating frequency (“Frequency [GHz]”).

Curve 626 shows the amplitude (“Magnitude [dB]”) of coefficient S22 in decibels of the transformer 300 of FIG. 3 as a function of the operating frequency (“Frequency [GHz]”).

Curve 628 shows the amplitude (“Magnitude [dB]”) of coefficient S21 in decibels of the transformer 100 of FIG. 1 as a function of the operating frequency (“Frequency [GHz]”).

Curve 629 shows the amplitude (“Magnitude [dB]”) of coefficient S21 in decibels of the transformer 300 of FIG. 3 as a function of the operating frequency (“Frequency [GHz]”).

For a frequency, coefficient S11 is 42-GHz approximately −18 dB for transformer 300, to be compared with −10 dB for transformer 100.

For a 42-GHz frequency, coefficient S22 is approximately −44 dB for transformer 300, to be compared with −12 dB for transformer 100.

For a 42-GHz frequency, coefficient S21 is approximately −1.1 dB for transformer 300, to be compared with −1.5 dB for transformer 100.

For a 42-GHz frequency, for the transformer 300 comprising offset conductive tracks as described in relation to FIGS. 3 and 4, the coefficients S11 and S22 are lower and the coefficient S21 is closer to 0 than for the transformer 100 of FIG. 1.

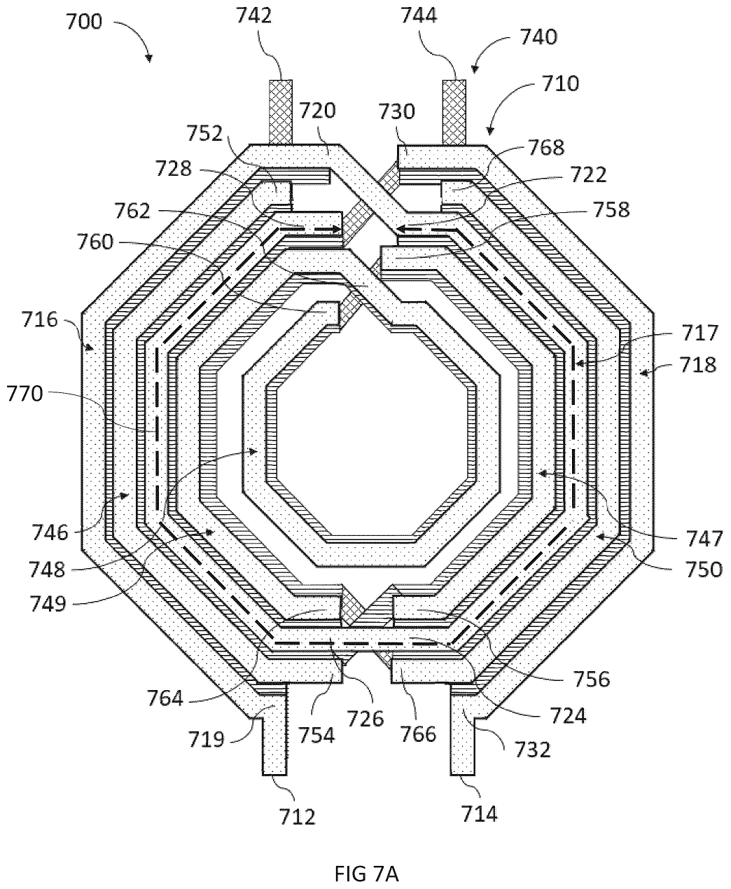

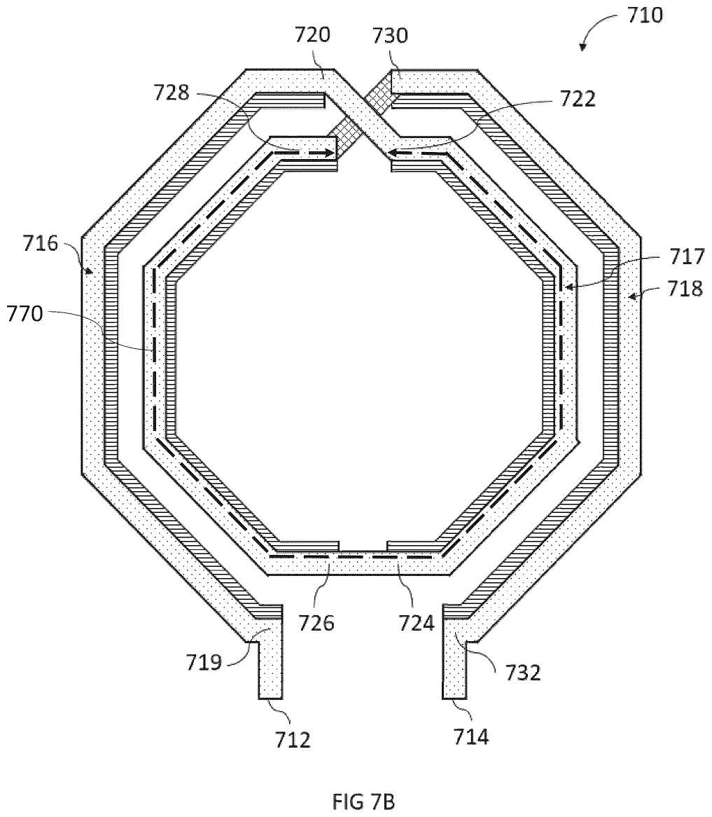

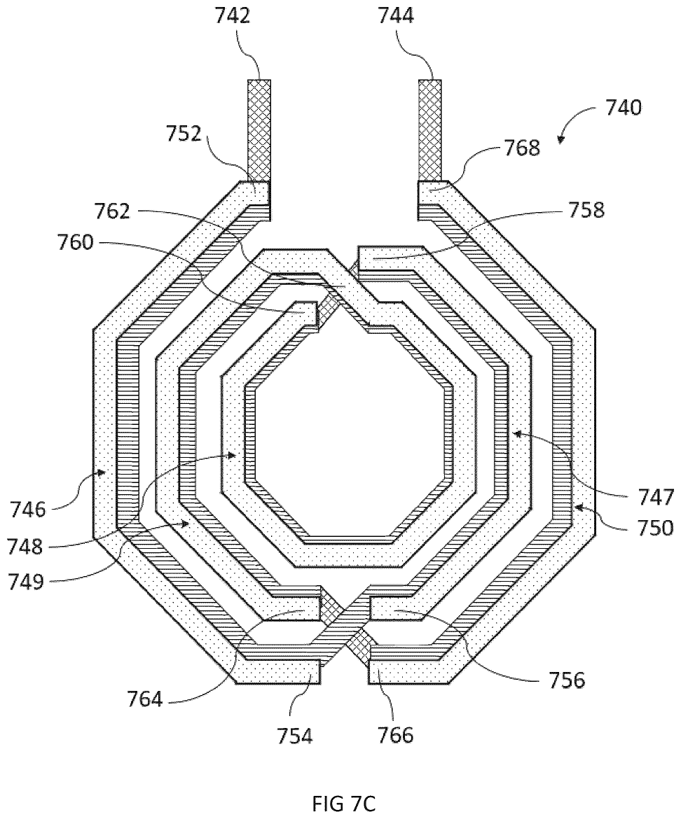

FIG. 7A is a top view of an example of transformer 700 according to an embodiment of the present disclosure. For example, transformer 700 is an impedance transformer.

FIG. 7B and FIG. 7C are top views of a first inductor 710 and of a second inductor 740 of the transformer 700 of FIG. 7A.

According to an embodiment, the first inductor 710 is connected to a first external electronic circuit (not shown in FIGS. 7A to 7C) and the second inductor 740 is connected to a second external electronic circuit (not shown in FIGS. 7A to 7C).

Transformer 700 comprises the first external inductor 710. Inductor 710 comprises two connection terminals, for example an input/output terminal 712 and an input/output terminal 714. Inductor 710, as shown in the example of FIG. 7A and of FIG. 7B, comprises two loops: a first loop formed of a first half-loop 716 and of a second half-loop 718, and a second loop 717, so that an electric current flowing through inductor 710 from its terminal 712 to its terminal 714 flows, in the order, through half-loop 716, then loop 717, and then half-loop 718. The first half-loop 716 couples an end 719 to an end 720. End 719 is for example coupled to connection terminal 712 by one or a plurality of conductive tracks. The second one 717 couples an end 722 to an end 728. End 722 is for example coupled to end 720 by one or a plurality of conductive tracks. The second half-loop 718 couples an end 730 to an end 732. End 730 is for example coupled to end 728 by one or a plurality of conductive tracks and/or one or a plurality of vias. End 732 is for example coupled to connection terminal 714 by one or a plurality of conductive tracks.

Transformer 700 comprises the second internal inductor 740. Inductor 740 comprises two connection terminals, for example an input/output terminal 742 and an input/output terminal 744. Inductor 740, as shown in the example of FIG. 7A and of FIG. 7C, comprises three loops: a first loop formed of a first half-loop 746 and of a second half-loop 750, a second loop formed of a first half-loop 747 and of a second half-loop 749, and a third loop 748. An electric current flowing through inductor 740 from its terminal 742 to its terminal 744 flows, in the order, through half-loop 746, then half-loop 747, then loop 748, then half-loop 749, then half-loop 750.

The first half-loop 746 of the first loop couples an end 752 to an end 754. End 752 is for example coupled to connection terminal 742 by one or a plurality of conductive tracks and/or one or a plurality of vias. The first half-loop 747 of the second loop couples an end 756 to an end 758. End 756 is for example coupled to end 754 by one or a plurality of conductive tracks and/or one or a plurality of vias. The third loop 748 couples an end 760 to an end 762. End 760 is for example coupled to end 758 by one or a plurality of conductive tracks and/or one or a plurality of vias. End 762 is for example the junction between half-loops 748 and 749. The second half-loop 749 of the second loop couples an end 762 to an end 764. The second half-loop 750 of the first loop couples an end 766 to an end 768. End 766 is for example coupled to end 764 by one or a plurality of conductive tracks and/or one or a plurality of vias. End 768 is for example coupled to connection terminal 744 by one or a plurality of conductive tracks and/or one or a plurality of vias.

As compared with the examples of FIGS. 1 and 3, in the example of FIG. 7A, the loops are substantially octagonal in shape instead of being substantially rectangular. In other embodiments, other loop shapes are possible.

In the example of the transformer 700 of FIG. 7A, the loops of inductors 710 and 740 are each formed of a stack of three conductive tracks distributed in levels L1, L2, and L3 according to the arrangement described in relation with FIG. 4. In particular, loop 717, loop 748, and each of half-loops 716, 718, 746, 747, 749, and 750 comprise conductive tracks in levels L1, L2, and L3 coupled together along the entire length of the loop. The conductive tracks coupling ends 758 and 760, 764 and 766, end 752 to connection terminal 742, and end 768 to connection terminal 744 comprise, for example, a single conductive track formed in a single level which is, for example, a level other than levels L1, L2, and L3. The conductive tracks coupling ends 754 and 756 comprise, for example, a single conductive track formed in a single level which is, for example, level L1. Generally, each of the inductor loops comprises at least two conductive tracks coupled together over at least half the loop length. For example, the loop 117 has a length 770, illustrated in FIG. 7A by a double-headed arrow.

The transformer 300 of FIG. 3 corresponds to the transformer 100 of FIG. 1, in which the conductive track 205 of loop 116 is offset from the conductive track 215 of loop 116.

Still referring to the example of transformer 700, the conductive tracks of level L1 of loop 717, loop 748, and each of half-loops 716, 718, 746, 747, 749, and 750 are laterally offset so that, at any point, in a cross-section view, the centers of mass of the conductive tracks of level L3 are laterally offset from the centers of mass of the conductive tracks of level L1, in the cross-section plane, in a direction parallel to the plane formed by the first conductive level L1. In this example, the conductive tracks of level L3 are offset towards the outside of inductors 710, 740. According to an alternative embodiment, the conductive tracks of level L3 are offset towards the inside of inductors 710, 740. The offset direction is selected according to the desired performance.

In FIGS. 7A to 7C, in top view, the tracks of level L3 are fully visible, and those of level L1 are partially visible, when they are not covered by tracks of higher levels. The tracks of level L2 are, in the example shown in FIGS. 7A to 7C, totally covered by the tracks of level L3 and are not visible.

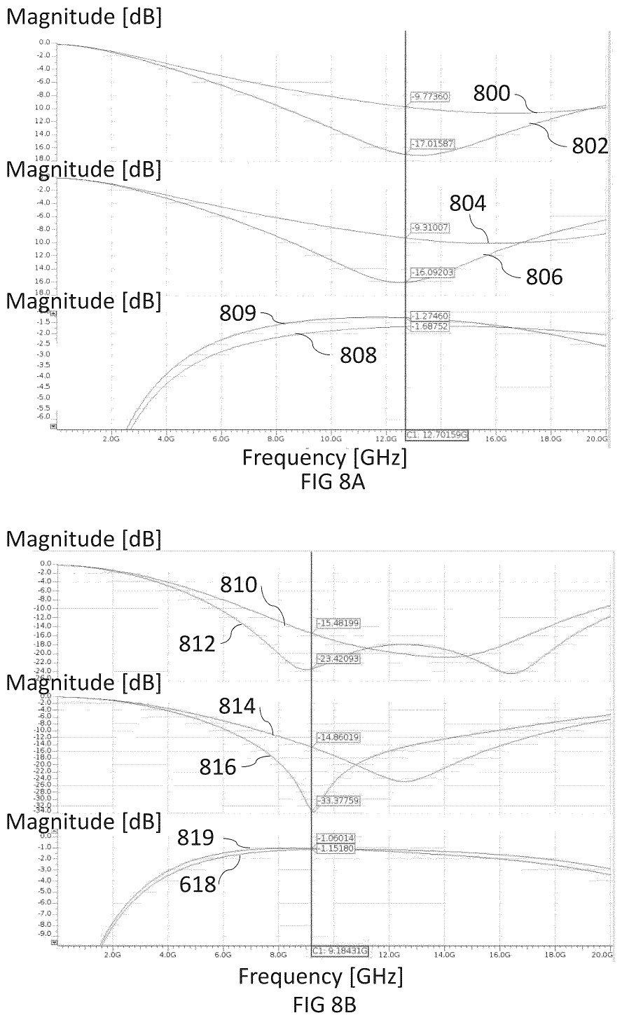

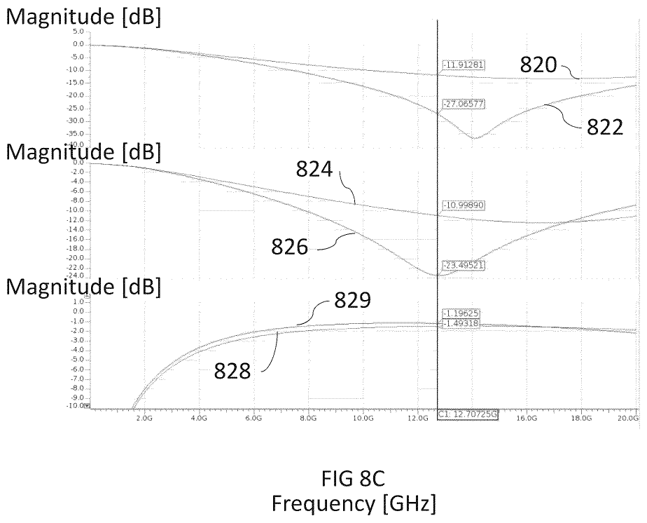

FIGS. 8A to 8C are graphs obtained by means of the digital simulation described in relation with FIG. 5A with the transformer 700 of FIG. 7A and with a second transformer similar to transformer 700 but exhibiting no offset between conductive tracks of a same loop. In the example of FIG. 8A, the capacitive elements are removed from the circuit used for the simulation. In the example of FIGS. 8B and 8C, the values of the first and second capacitive elements used in the simulation are adjusted as a function of the operating frequency of the transformer to optimize the power adaptation and the power transfer of the considered transformer. FIGS. 8A to 8C show reflection coefficients S11 exhibited by the primary circuit of the transformer comprising the first capacitive element and inductor 110, and S22 exhibited by the secondary circuit of the transformer comprising the second capacitive element and inductor 140, characterizing the proportion of power reflected between the considered circuit and what is connected thereto. On design of a transformer, it is desirable for parameters S11 and S22 to be as low as possible, which means that the power reflected at the transformer is decreased, preferably to a minimum. A third parameter, S21, is shown in FIGS. 8A to 8C. It is the power gain or loss of the considered transformer. On design of a transformer, it is desirable for S21 to be as close to 1 as possible, or as close to 0 dB as possible, which indicates that losses relative to the transformer in the considered environment are low, and the power transmitted through the transformer is increased.

FIG. 8A is a graph showing the scattering parameters: S11, S22, and S21 of signal transmission by the transformer 700 of FIG. 7A and the quality parameters S11, S22, and S21 of the second transformer at a 12-GHz frequency.

Curve 800 shows the amplitude (“Magnitude [dB]”) of the coefficient S11 in decibels of the second transformer as a function of the operating frequency (“Frequency [GHz]”).

Curve 802 shows the amplitude (“Magnitude [dB]”) of the coefficient S11 in decibels of the transformer 700 of FIG. 7A as a function of operating frequency (“Frequency [GHz]”).

Curve 804 shows the amplitude (“Magnitude [dB]”) of the coefficient S22 in decibels of the second transformer as a function of the operating frequency (“Frequency [GHz]”).

Curve 806 shows the amplitude (“Magnitude [dB]”) of the coefficient S22 in decibels of the transformer 700 of FIG. 7A as a function of the operating frequency (“Frequency [GHz]”).

Curve 808 shows the amplitude (“Magnitude [dB]”) of the coefficient S21 in decibels of the second transformer as a function of the operating frequency (“Frequency [GHz]”).

Curve 809 shows the amplitude (“Magnitude [dB]”) of the coefficient S21 in decibels of the transformer 700 of FIG. 7A as a function of the operating frequency (“Frequency [GHz]”).

For a 12-GHz frequency, without using capacitive elements external to the impedance transformers during the simulation, coefficient S11 is approximately −17 dB for transformer 700, to be compared with −10 dB for the second transformer.

Coefficient S22 is approximately −16 dB for transformer 700, to be compared with −9 dB for the second transformer.

Coefficient S21 is approximately −1.3 dB for transformer 700, to be compared with −1.7 dB for the second transformer.

For a 12-GHz frequency, for transformer 700 comprising offset conductive tracks as described in relation with FIGS. 3 and 4, coefficients S11 and S22 are lower and coefficient S21 is closer to 0 than for the second transformer.

FIG. 8B is a graph showing the scattering parameters: S11, S22, and S21 of the signal transmission by the transformer 700 of FIG. 7A and the quality parameters S11, S22, and S21 of the second transformer at a 9-GHz frequency.

In the example of FIG. 6B, the first and second capacitances used for the digital simulation are 140 fF and 60 fF.

Curve 810 shows the amplitude (“Magnitude [dB]”) of the coefficient S11 in decibels of the second transformer as a function of the operating frequency (“Frequency [GHz]”).

Curve 812 shows the amplitude (“Magnitude [dB]”) of the coefficient S11 in decibels of the transformer 700 of FIG. 7A as a function of the operating frequency (“Frequency [GHz]”).

Curve 814 shows the amplitude (“Magnitude [dB]”) of the coefficient S22 in decibels of the second transformer as a function of the operating frequency (“Frequency [GHz]”).

Curve 816 shows the amplitude (“Magnitude [dB]”) of the coefficient S22 in decibels of the transformer 700 of FIG. 7A as a function of the operating frequency (“Frequency [GHz]”).

Curve 818 shows the amplitude (“Magnitude [dB]”) of the coefficient S21 in decibels of the second transformer as a function of the operating frequency (“Frequency [GHz]”).

Curve 819 shows the amplitude (“Magnitude [dB]”) of the coefficient S21 in decibels of the transformer 700 of FIG. 7A as a function of the operating frequency (“Frequency [GHz]”).

For a 9-GHZ frequency, coefficient S11 is approximately −23 dB for transformer 700, to be compared with −15 dB for the second transformer.

Coefficient S22 is approximately −33 dB for transformer 700, to be compared with −15 dB for the second transformer.

Coefficient S21 is approximately −1.3 dB for transformer 700, to be compared with −1.2 dB for the second impedance transformer.

For a 9-GHz frequency, for transformer 700 comprising offset conductive tracks as described in relation with FIGS. 3 and 4, coefficients S11 and S22 are lower and coefficient S21 is closer to 0 than for the second transformer.

FIG. 8C is a graph showing the scattering parameters: S11, S22, and S21 of signal transmission by the transformer 700 of FIG. 7A and the quality parameters S11, S22, and S21 of the second transformer at a 13-GHz frequency.

The first capacitive element used for the digital simulation has a 60-fF value, and the second capacitive element is not connected.

Curve 820 shows the amplitude (“Magnitude [dB]”) of the coefficient S11 in decibels of the second transformer as a function of the operating frequency (“Frequency [GHz]”).

Curve 822 shows the amplitude (“Magnitude [dB]”) of the coefficient S11 in decibels of the transformer 700 of FIG. 7A as a function of the operating frequency (“Frequency [GHz]”).

Curve 824 shows the amplitude (“Magnitude [dB]”) of the coefficient S22 in decibels of the second transformer as a function of the operating frequency (“Frequency [GHz]”).

Curve 826 shows the amplitude (“Magnitude [dB]”) of the coefficient S22 in decibels of the transformer 700 of FIG. 7A as a function of the operating frequency (“Frequency [GHz]”).

Curve 828 shows the amplitude (“Magnitude [dB]”) of the coefficient S21 in decibels of the second transformer as a function of the operating frequency (“Frequency [GHz]”).

Curve 829 shows the amplitude (“Magnitude [dB]”) of the coefficient S21 in decibels of the transformer 700 of FIG. 7A as a function of the operating frequency (“Frequency [GHz]”).

For a 12.7-GHz frequency, coefficient S11 is approximately −27 dB for transformer 700, to be compared with −12 dB for the second impedance transformer.

Coefficient S22 is approximately −44 dB for transformer 700, to be compared with −12 dB for the second impedance transformer.

Coefficient S21 is approximately −1.1 dB for transformer 700, to be compared with −1.5 dB for the second transformer.

For a 12.7-GHZ for transformer frequency, 700 comprising offset conductive tracks as described in relation with FIGS. 3 and 4, coefficients S11 and S22 are lower and coefficient S21 is closer to 0 than for the second transformer.

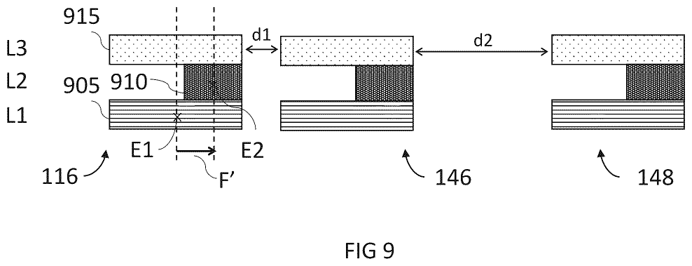

FIG. 9 is a partial cross-section view of the transformer of FIG. 1, according to another example than that of FIG. 2 and according to an embodiment of the present disclosure.

Certain elements of FIG. 9 correspond to elements of FIGS. 1 to 4. These elements are designated with a same reference and are not described again in detail.

FIG. 9 shows an alternative to FIG. 2. Instead of an offset between the conductive tracks 305 of the layer L1 and 315 of the layer L3 of transformer 300 as described in relation with FIGS. 3 and 4, in the example of FIG. 9, the offset is, for example, achieved between the conductive tracks 905 of the layer L1 and 910 of the layer L2 of loop 116.

Conductive track 910, for example formed by one or a plurality of conductive vias, is laterally offset so that, for any point of loop 116, in a cross-section view, the center of mass E2 of conductive track 910 is laterally offset from the center of mass E1 of conductive track 905, in the cross-section plane, in a direction parallel to the plane formed by the first conductive level L1. The offset is represented by an arrow F′.

An example of a manufacturing method is detailed hereafter for the transformer 100 of FIGS. 1 and 9. Similar methods are used, for example, to manufacture the transformer 300 of FIG. 3 and 700 of FIG. 7A.

The method comprises, for example:
a step of forming, in a first level L1 of a structure, the conductive track 905 of loop 116, of inductor 110,
a step of forming, in a second level L2 of the structure, one or a plurality of vias forming the conductive track 910 of loop 116;
a step of forming, in a third level L3 of the structure, the conductive track 915 of loop 116, conductive tracks 905, 910, and 915 being electrically connected together directly over at least half, or approximately half, the length of loop 116. Over at least half, or approximately half, the length of loop 116, conductive tracks 905 and 910 are arranged so that, in a cross-section view perpendicular to the length of loop 116, the center of mass E1 of conductive track 905 is laterally offset from the center of mass E2 of conductive track 910 in the cross-section plane, and in a direction parallel to the plane formed by level L1.

In other embodiments, for the transformer 300 of FIGS. 3 and 4, over at least half the length of loop 116, conductive tracks 305 and 315 are arranged so that, in a cross-section view perpendicular to the length of loop 116, the center of mass D1 of conductive track 305 is laterally offset from the center of mass D3 of conductive track 315 in the cross-section plane, and in a direction parallel to the plane formed by level L1.

According to the described embodiments, the offset between two conductive tracks of a loop of an inductor of a transformer increases the mutual coupling between inductors as well as the capacitive coupling and enables to improve the reflection and transmission gain coefficients of the transformer. The increase of the capacitive coupling enables to decrease the value of or to remove capacitive elements external to the transformer in the concerned electronic circuits. This improves the compactness of the transformer.

Having a transformer comprising one loop having a first conductive track and a second conductive track electrically connected over at least half the length of the loop has the advantage of lowering the series resistance of the loop and increasing the quality factor of the transformer.

Various embodiments and variants have been described. Those skilled in the art will understand that certain features of these various embodiments and variants may be combined, and other variants will occur to those skilled in the art. In particular, examples of configurations of impedance transformers 300, 700 have been disclosed, but the inductors and loops may have other shapes and arrangements. A lateral offset of a track 205 towards the outside of loop 116 has been illustrated, but an offset towards the inside of the loop is also possible. The loops of the shown impedance transformers 100, 300, 700 comprise three conductive tracks connected over the length of the loop or over at least half the length of the loop. According to some embodiments, the loops of the impedance transformers 100, 300, 700 comprise conductive tracks connected to each other discontinuously such that, by adding the length of the connections, the conductive tracks are connected to each other at least half the length of the loop. A greater number of conductive tracks is also possible.

1. A transformer comprising, in a laminated structure, a first inductor and a second inductor, wherein the first inductor comprises:
a first loop comprising a first conductive track in a first level of the structure and a second conductive track in a second level of the structure, the first and second conductive tracks being adapted to being electrically connected to each other directly, or via an intermediate conductive track, over at least half a length of the first loop; and
wherein, over at least half the length of the first loop, the first and second conductive tracks are arranged so that, in a cross-section plane perpendicular to the length of the first loop, a center of mass of the first conductive track is laterally offset from the center of mass of the second conductive track in the cross-section plane, and in a direction parallel to the plane formed by the first level.

2. The transformer of claim 1, wherein the first and second conductive tracks are connected to each other by the intermediate conductive track, the intermediate conductive track comprising one or a plurality of vias.

3. The transformer of claim 1, the first loop further comprising a third conductive track electrically connected to the second conductive track over at least half the length of the first loop, wherein the second conductive track comprises one or a plurality of vias coupling the first conductive track to the third conductive track.

4. The transformer of claim 1, wherein the second inductor comprises a first loop comprising a fourth conductive track in the first level of the structure and a fifth conductive track in the second level of the structure.

5. The transformer of claim 4, wherein the first conductive track of the first loop of the first inductor in the first level at least partially faces the fifth track of the first loop of the second inductor in the second level.

6. A method of manufacturing a transformer comprising, in a laminated structure, a first inductor and a second inductor, the method comprising:
forming, in a first level of the structure, of a first conductive track of a first loop of a first inductor;
forming, in a second level of the structure, of a second conductive track of the first loop, the first and second conductive tracks being adapted to being electrically connected to each other directly, or via an intermediate conductive track, over at least half a length of the first loop; and
wherein, over at least half the length of the first loop, the first and second conductive tracks are arranged so that, in a cross-section plane perpendicular to the length of the first loop, a center of mass of the first conductive track is laterally offset from the center of mass of the second conductive track in the cross-section plane, and in a direction parallel to the plane formed by the first level.

7. The method of claim 6, wherein the first and second conductive tracks are connected to each other by the intermediate conductive track, the method further comprising, after the forming of the first conductive track and before the forming of the second conductive track, the forming of at least one via forming the intermediate conductive track on the first conductive track, the second conductive track being formed on the at least one via so that the first and second conductive tracks are electrically connected to each other via the at least one via.

8. The method of claim 6, wherein the second conductive track comprises one or a plurality of vias, the method further comprising, after the forming of the second conductive track, the forming of a third conductive track on the second conductive track, the third conductive track being electrically connected to the second conductive track over at least half the length of the first loop.

9. The method of claim 6, further comprising:
forming, in the first level of the structure, of a fourth conductive track of a first loop of the second inductor; and
forming, in the second level of the structure, of a fifth conductive track of the first loop of the second inductor.

10. The method of claim 9, wherein the fifth track of the first loop in the second level is formed in such a way that the first conductive track of the first loop in the first level at least partially faces the fifth track of the first loop in the second level.
